(19) United States
(12) Patent Application Publication
(10) Pub. No.: US 2016/0116985 A1
(43) Pub. Date: Apr. 28, 2016

(54) UNIVERSAL TRANSLATOR FOR RECOGNIZING NONSTANDARD GESTURES

(71) Applicant: PURDUE RESEARCH FOUNDATIO, West Lafayette, IN (US)

(72) Inventors: Bradley S. Duerstock, West Lafayette, IN (US); Juan P. Wachs, West Lafayette, IN (US); Hairong Jiang, San Jose, CA (US)

(73) Assignee: PURDUE RESEARCH FOUNDATION, West Lafayette, IN (US)

(21) Appl. No.: 14/872,062

(22) Filed: Sep. 30, 2015

Related U.S. Application Data
(60) Provisional application No. 62/057,312, filed on Sep. 30, 2014.

(51) Int. Cl. G06F 3/01

(52) U.S. Cl. CPC G06F 3/017

(57) ABSTRACT

A system and method to project gesture patterns of gestural behavior designed for existing gesture systems to those exhibited by persons with limited upper limb mobility, such as quadriplegics due to spinal cord injury (SCI), hemiplegics due to stroke, and persons with other types of disabilities. The system acquires a plurality of gesture instances from a gesture sensor, maps the plurality of gesture instances, determines a union amongst the plurality of gesture instances to thereby acquire a plurality of trajectory points, encodes the plurality of trajectory points into a feature vector, extracts a plurality of features from the feature vector, normalizes the plurality of features, determines at least one transform function from the plurality of features, and generates constrained gestures from the at least one transform function to form at least one gesture set.

### RELATED APPLICATIONS

The present application claims the benefit of U.S. provisional application Ser. No. 62/057,312, filed Sep. 30, 2014, the contents of which are hereby incorporated by reference in its entirety.

### STATEMENT OF GOVERNMENT INTEREST

This invention was made with government support under GM096842 awarded by the National Institutes of Health. The government has certain rights in the invention.

### TECHNICAL FIELD

The present disclosure generally relates to gesture recognition systems, and in particular to a gesture recognition that incorporates a user's motor limitations or idiosyncratic movements of a specific group within the population.

### BACKGROUND

This section introduces aspects that may help facilitate a better understanding of the disclosure. Accordingly, these statements are to be read in this light and are not to be understood as admissions about what is or is not prior art.

In the last few years, gesture-based interfaces have become increasingly popular for applications, such as entertainment, healthcare, robotics, communication, and transportation. The application that has received most traction is arguably “gaming”. Recent studies have also shown that playing games can substantially improve the well-being and recovery of function in stroke, multiple-sclerosis and Parkinson's disease rehabilitation patients. Unfortunately, commercial gesture-based consoles, such as the Wii® and XBOX®, have been developed without considering users' motor limitations. While there have been individual, spontaneous, and unstructured customizing gesture-based interfaces developed for people with disabilities (PWDs), for most, these systems lead to suboptimal solutions, and adopted ad-hoc methods, rather than generalizable solutions.

There is no existing methodology to convert a gesture-based interface designed for able-bodied individuals to a usable and effective interface for PWDs without redesigning the interface from scratch. Previous work leveraged on the theory of Laban movement analysis (LMA) proposed by Laban to characterize gestures. This theory can be of paramount importance for finding the common patterns in gestures performed by PWDs. The LMA method utilizes various major performance components (e.g. Body, Space, Shape and Effort, among other components). To simplify its representation, Norman Badler developed a special notation called “Labanotation” to describe human movements using LMA. Rett and Dias discussed the modeling and implementation of LMA. Santos and Dias focused on converting and interpreting human motion signals into a series of features based on the study of body trajectories. The main contribution of their work was the design of the gesture lexicon consisting of many motion-entities which were defined though LMA parameters. To analyze the relationships between these motion entities, Bayesian networks can be applied.

The use of LMA for characterizing gesture sets is part of a more generalized approach for determining gestural vocabularies, called “analytical-based” vocabularies. This type of approach builds on mathematical models to determine an optima gesture set (lexicon). There are also the “technology-based” and “human-based” approaches. The gestures selected by the technology-based approach were easily “recognizable” by the machine, however may be difficult to perform and remember by quadriplegic users. In contrast, the human-based approach established the gesture vocabulary by maximizing usability-based metrics (e.g. such as satisfaction and comfort).

There is currently an unmet need to project existing patterns of gestural behavior to correspond to those of users with upper extremity mobility impairments, thereby making commercial gesture-based interfaces widely usable by quadriplegics, amputees, hemiplegics, and others.

### SUMMARY

According to one aspect, a method is provided, comprising acquiring a plurality of gesture instances from a gesture sensor, mapping the plurality of gesture instances, determining a union amongst the plurality of gesture instances to thereby acquire a plurality of trajectory points, encoding the plurality of trajectory points into a feature vector, extracting a plurality of features from the feature vector, normalizing the plurality of features, computing at least one transform function from the plurality of features, and generating constrained gestures from the at least one transform function to form at least one gesture set.

According to another aspect, a system is provided, comprising a gesture sensor configured to sense physical gestures performed by a user and a controller having a processor and a memory. The controller is configured to acquire a plurality of gesture instances from the gesture sensor, map the plurality of gesture instances, determine a union amongst the plurality of gesture instances to thereby acquire a plurality of trajectory points, encode the plurality of trajectory points into a feature vector, extract a plurality of features from the feature vector, normalize the plurality of features, determine at least one transform function from the plurality of features, and generate constrained gestures from the at least one transform function to form at least one gesture set.

### BRIEF DESCRIPTION OF THE DRAWINGS

FIG. 1a shows an architecture of the analytic gesture generation according to one embodiment.

FIG. 1b shows a continuation and completion of the architecture of FIG. 1a.

FIG. 2 shows a pseudo-random gesture generation process which uses a combination of a gesture encoding approach and a neighborhood search method according to one embodiment.

FIGS. 3a-3f show sample results for the gesture generation method of FIG. 1.

FIGS. 4a-4d represent standard gesture lexicons for “Xbox” (FIG. 4a), “PointGrab” (FIG. 4b), “Win8” (FIG. 4c), and “Wisee” (FIG. 4d) according to one embodiment.

FIGS. 5a-5g represent the set of candidate gestures (k) resulting from the gesture recognition process of FIG. 1

FIG. 6 shows the average Borg scale ranking for a plurality of tested subject using the gesture recognition method of FIG. 1.

FIG. 7 shows the index of constrained gestures selected by the subjects of FIG. 6.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

In response to the need to project existing patterns of gestural behavior to correspond to those of users with upper extremity mobility impairments, thereby making commercial gesture-based interfaces widely usable by quadriplegics, hemiplegics, and amputees, this disclosure presents three main contributions: (a) propose a new analytical approach based on transforming gestures from different manifold spaces, called the Laban Transform; (b) project existing gesture lexicons from commercial gesture recognition applications into a new set of gestures suitable for users with upper limb mobility impairments; and (c) validate and determine the usability of the constrained gestures with users.

The present disclosure addresses how to project standard gestures from a known manifold to a constrained (unknown) manifold that corresponds to the space and effort that persons with quadriplegia can perform. The term “standard gestures” is shall be interpreted to mean gestures designed for able-bodied individuals. A “standard gesture lexicon” shall be interpreted to mean a set of standard gestures used for a gesture-based interface. To meet the goal of making commercial consoles available for users with disabilities, L standard gesture lexicons (denoted as Q₁, Q₂ . . . 2_{L} are selected. The union is denoted as ℑ (Eq. 1).

ℑ=Q₁ ∪Q₂ . . . ∪Q_{L} (1)

Let G represent a standard lexicon with N gestures, where G⊂ℑ. \tilde{G} is a constrained gesture lexicon corresponding to G, gₙ and \tilde{g}ₙ (n=1, 2, . . . , N) denote the nth gesture in G and \tilde{G}, respectively (Eq. 2 and Eq. 3). Let ĝ denote an arbitrary gesture, [symbol] represents a mapping from a gesture trajectory to a feature vector, and Ψ be a pre-trained transform function between the feature vector of a standard gesture and that of a constrained gesture (details presented in further detail below). The problem is interpreted as: finding a constrained gesture lexicon to satisfy (Eq. 4 and 5).

G={g₁,g₂, . . . , gₙ, . . . , g_{N}}(n=1,2, . . . , N) (2)

\tilde{G}={\tilde{g}₁\tilde{g}₂, . . . , \tilde{g}ₙ, . . . , \tilde{g}_{N}}(n=1,2, . . . ,N) (3)

$${\tilde{ℊ}}_{n} = {arg min}_{\breve{ℊ}} ‖ ℒ ( \breve{ℊ} ) - Ψ ( ℒ ( {ℊ}_{n} ) ‖ \qquad ( 4 )$$

s.t. n≦N ,n∈ [symbol] ⁺, gₙ∈G, and \tilde{g}ₙ∈\tilde{G} (5)

An analytic approach is presented as a solution to this problem (minimize Eq. 4). A set of gestures are collected to train the model and once the model is trained, it is tested using a testing lexicon. The union of the standard gesture lexicons ℑ is further divided into two subsets: one is used to collect the gesture instances for training (denoted as [symbol] ₜᵣₐᵢₙ) and the other is used for testing (denoted as [symbol] ₜₑₛₜ), where Eq. 6 is satisfied ġᵢ and g̅ⱼ represent the gesture in [symbol] ₜᵣₐᵢₙ and [symbol] ₜₑₛₜ, Nₜᵣₐᵢₙ and Nₜₑₛₜ are the number of gestures in [symbol] ₜᵣₐᵢₙ and [symbol] ₜₑₛₜ (Eq. 7 and Eq. 8).

[symbol]

ₜᵣₐᵢₙ ∪ [symbol] ₜₑₛₜ=ℑ, [symbol] ₜᵣₐᵢₙ ∩ [symbol] ₜₑₛₜ=Ø (6)

[symbol]

ₜᵣₐᵢₙ={ g̅₁, g̅₂, . . . , g̅ᵢ, . . . , g̅_{N}_{ₜᵣₐᵢₙ}}(i=1,2, . . . , Nₜᵣₐᵢₙ) (7)

[symbol]

ₜₑₛₜ={ g̅₁, g̅₂, . . . , g̅ⱼ, . . . , g̅_{N}_{ₜₑₛₜ}}(j=1,2, . . . ,Nₜₑₛₜ) (8)

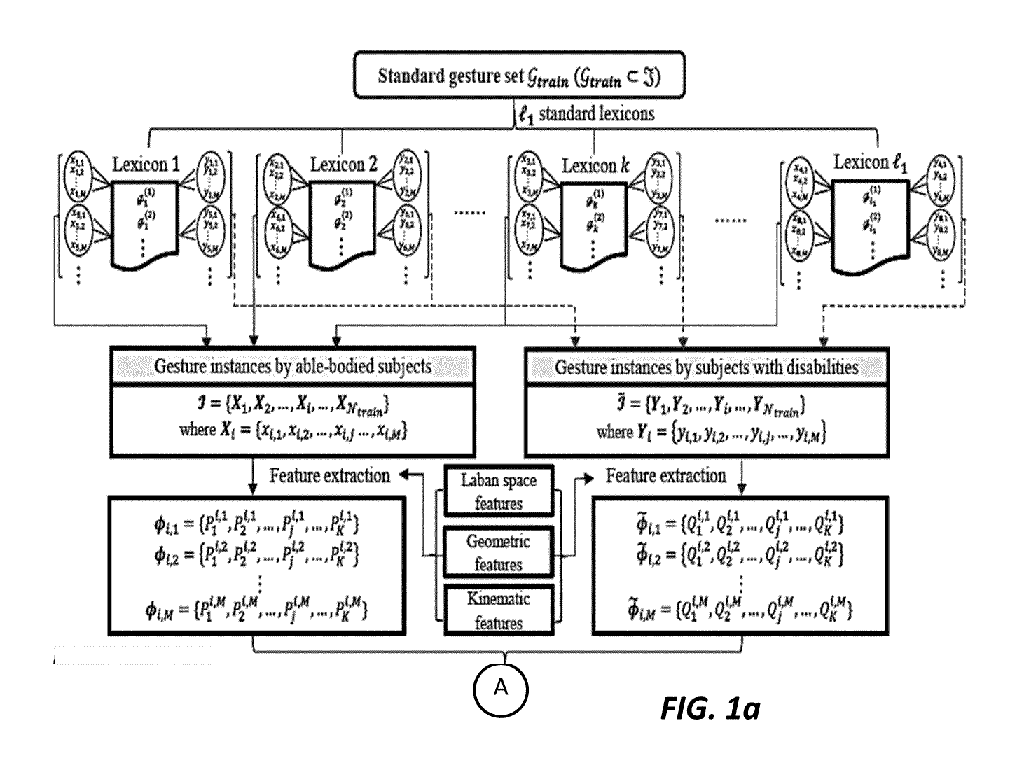

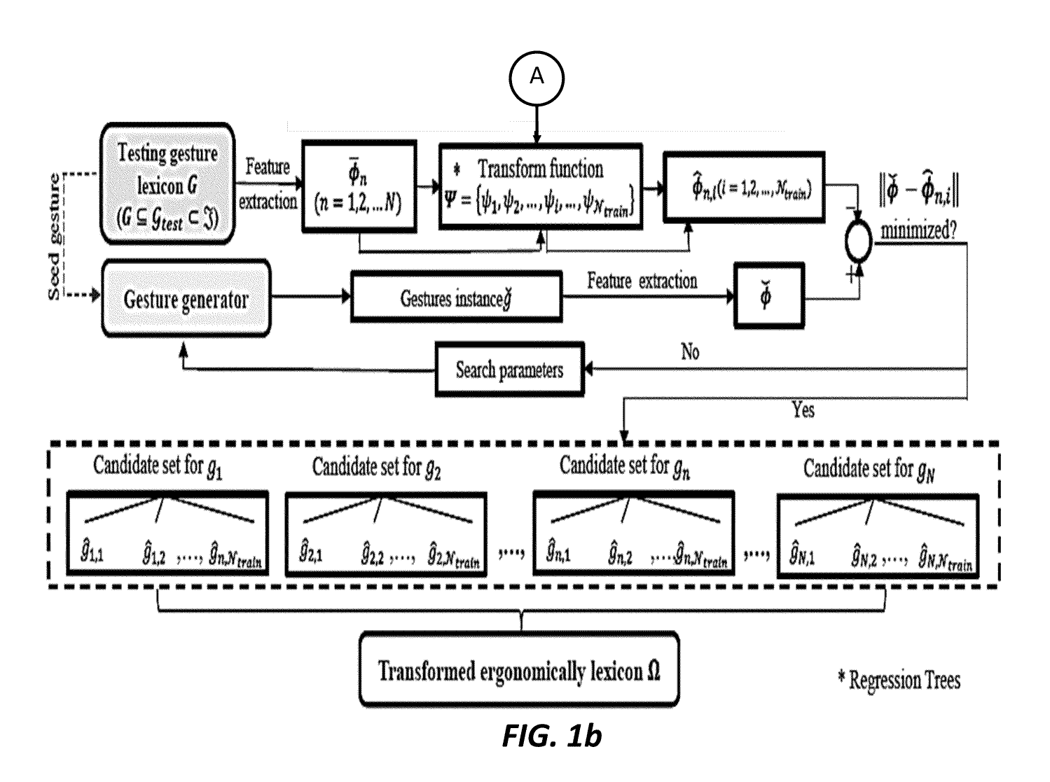

The architecture of the analytic gesture generation approach to solve the problem described above is shown in FIGS. 1a and 1b. This approach consists of the following four steps: sections A-D below.

A. Acquiring and Preprocessing Gesture Trajectories:

To collect the gesture instances (trajectories) for training, both able-bodied and quadriplegic subjects were recruited. Each gesture ( g̅ᵢ) in [symbol] ₜᵣₐᵢₙ was presented to subjects via slideshows. The subjects were then asked to perform each gesture M times and to follow the presented gesture trajectory as much as possible. While the subject performed a given gesture, the 3D coordinates of the hands were acquired using a color and depth sensor (e.g., a Kinect camera). Each gesture instance (j) obtained from a trial (i) is denoted as for able-bodied subjects, and y_{i,j} for subjects with quadriplegia (Eq. 9 and Eq. 10). Here, one trial corresponds to the gestures generated from one slide in the slideshow. The function [symbol] represents the mapping from the subjects' performance of a gesture to the corresponding trajectory. The set of instances for each standard gesture is denoted as Xᵢ and Yᵢ (Eq. 11 and Eq. 12). Following this procedure, the set of gesture instances collected from able-bodied individuals (denoted as [symbol] ) and subjects with quadriplegia (denoted as [symbol] ) is obtained (Eq. 13 and Eq. 14). The union ( [symbol] ) of all the gesture instances is expressed in Eq. 15.

Two steps (outlier removal and smoothing) were employed for the acquired gesture instances to reduce noise and the variability exhibited by the users. Outliers were those trajectory points further than 3σ from the mean. A Kalman filter is employed to smooth the 3D gesture trajectories.

x_{i,j}= [symbol] ( g̅ᵢ) (9)

y_{i,j}= [symbol] ( g̅ᵢ) (10)

Xᵢ={x_{i,1},x_{i,2}, . . . , x_{i,j}, . . . , x_{i,M}} (11)

Yᵢ={y_{i,1}, y_{i,2}, . . . , y_{i,j}, . . . , y_{i,M}} (12)

[symbol]

={X₁, X₂, . . . , Xᵢ, . . . , X_{N}_{ₜᵣₐᵢₙ}} (13)

[symbol]

={Y₁, Y₂, . . . , Yᵢ, . . . , Y_{N}_{ₜᵣₐᵢₙ}} (14)

[symbol]

={ [symbol] , [symbol] } (15)

B. Feature Extraction:

Each gesture trajectory is encoded into a feature vector with dimensionality K (number of features per gesture). Two principles are followed for feature selection; (a) generable: representative of the user target population (e.g. quadriplegics); and b) separable: differentiable between standard gestures and those within the constrained gesture space. To satisfy the aforementioned requirements, a union made of Laban space, and kinematic and geometric based features was created.

The Laban space features can provide a good representation of the limitations experienced by people with upper extremity physical impairments. Features based on Space, Effort, and Shape were adopted. The symbolic representation developed by Longstaff et al., is used to extract features representing the Space component. The Effort component is expressed by directness, inertia, and duration of a gesture trajectory. The volume of the trajectory is used to quantify the Shape component. The kinematic characteristics of a given gesture trajectory are described by the velocity, acceleration, and jerk component of the motion. The average, maximum and minimum value of these three parameters are selected to construct the kinematic feature set. Each of them is extracted from the gesture trajectory and treated as a component of the feature vector. Since the gesture trajectory is a curve, its geometric characteristics can be represented using four features often used for curve representation: arc length, curvature, torsion, and number of inflection points. These features are adopted as a complement to the kinematic features, and they are key differentiators of the standard and constrained gestures. The extracted features are normalized to lie within the 0-1 range.

C. Transform Functions Computation:

This section describes the process of acquiring a set of transform functions associated with the set of gesture instances [symbol] . Let Φ_{i,j} ∈ [symbol] ^{K} (Eq. 16) denote a vector comprised by all the features extracted from a gesture instance. Similarly, \tilde{Φ}_{i,j} ∈ [symbol] ^{K} (Eq. 17) is a vector consisting of all the features extracted from a constrained gesture instance y_{i,j} (i=1,2, . . . , Nₜᵣₐᵢₙ; j=1, 2, . . . , M). [symbol] represents the projection from a gesture instance to a feature vector. Let the set consisting of all the feature vectors associated with a given gesture g̅ᵢ for able and disabled bodied individuals be Φᵢ and \tilde{Φ}ᵢ, respectively (Eq. 18 and 19). The transform function (ψᵢ) for each gesture g̅ᵢ in [symbol] ₜᵣₐᵢₙ is then computed using regression trees in the following way: for each transform function ψᵢ, a binary regression tree is obtained based on the input and output variables Φᵢ and \tilde{Φ}ᵢ (Eq. 20) so a regression error is minimized. The set of transformation functions (Ψ) for all the gestures in the standard lexicon is given by Ψ={Ψ₁, Ψ₂, . . . , Ψᵢ, . . . , Ψ_{N}_{ₜᵣₐᵢₙ}}.

Φ_{i,j}= [symbol] (x_{i,j}) (16)

\tilde{Φ}_{i,j}= [symbol] (y_{i,j}) (17)

Φᵢ=[Φ_{i,1}, Φ_{i,2}, . . . , Φ_{i,M}] (18)

\tilde{Φ}ᵢ=[\tilde{Φ}_{i,1}, \tilde{Φ}_{i,2}, . . . ,\tilde{Φ}_{i,M}] (19)

(\tilde{Φ}ᵢ)_{K×M}=(Ψᵢ)_{K×K}(Φᵢ)_{K×M} (20)

D. Constrained Gesture Generation:

A two-step iterative process is proposed to generate a candidate gesture set using the acquired transform function Ψ and a gesture generator. The first step consists of projecting the feature vector of a gesture from the standard to the constrained space usingΨ. The second step consists of generating gestures in the vicinity space of the given arbitrary gesture through a gesture generator. The generated gesture's feature vector is then compared to the constrained feature vector. If the distance between the two vectors is minimum (the distance does not decreases more than ε), then the gesture is kept as a candidate gesture. Otherwise, the gesture is discarded and a new gesture is generated. This process is iteratively conducted until a complete candidate set is obtained for all the gestures in the testing lexicon.

In the first step, a gesture lexicon G⊂ [symbol] ₜₑₛₜ is selected for testing (see above). Able-bodied subjects are asked to perform M times each gesture gₙ in G. The set of collected gesture instances for is converted to trajectories following a similar process as the one explained in section A above, and is denoted as \check{X}ₙ. Then, the gesture encoding approach proposed by Calinon et al. is applied to obtain the mean gesture trajectory from the set of trajectories \check{X}ₙ. This consists of building a Gaussian Mixture Model (GMM) from 3D trajectories' data points of all the gesture instances in \hat{X}ₙ. To determine the parameters of the Gaussians, the Expectation Maximization algorithm is used. The K-means clustering technique may be used to give the initial estimate of these parameters. Then the mean gesture trajectory (denoted as g̅ₙ) is obtained using Gaussian Mixture Regression (GMR). To obtain the GMR, the joint density is computed using the parameters estimated before, from the GMM. This way, GMM and GMR are used to encode the gesture trajectories collected from able-bodied subjects and obtain a mean standard gesture trajectory. The feature vector denoted as Φ̅ₙ(n=1,2, . . . , N) with features presented as in Section B above) is computed for each mean gesture trajectory \check{g}ₙ (Eq. 21). The transform function Ψ={Ψ₁, Ψ₂, . . . , Ψ₂, . . . , Ψ_{N}_{ₜᵣₐᵢₙ}} then applied to map Φ̅ₙ to a set of constrained feature vector \hat{Φ}_{n,i}(i=1,2, . . . , Nₜᵣₐᵢₙ) (Eq. 22). Thus, for each gesture ĝ_{n,}Nₜᵣₐᵢₙ constrained feature vectors (\hat{Φ}_{n,1}, \hat{Φ}_{n,2}, . . . , \hat{Φ}_{n,i}, . . . , \hat{Φ}_{n,N}_{ₜᵣₐᵢₙ}) are projected using Ψ. The feature vectors acquired in this step represent the characteristic constrained gesture trajectories. The goal is to determine the constrained gestures from the constrained feature vectors' available information. However, since the trajectories possess more information than their corresponding feature vectors, the process of obtaining a gesture trajectory from its inverse Laban transform [symbol] ⁻¹( Φ̅ₙ)=gₙ is not analytically possible.

Φ̅ₙ= [symbol] (\check{g}ₙ)(n=1,2, . . . ,N) (21)

\hat{Φ}_{n,i}=Ψᵢ( Φ̅ₙ)(i=1,2, . . . ,Nₜᵣₐᵢₙ) (22)

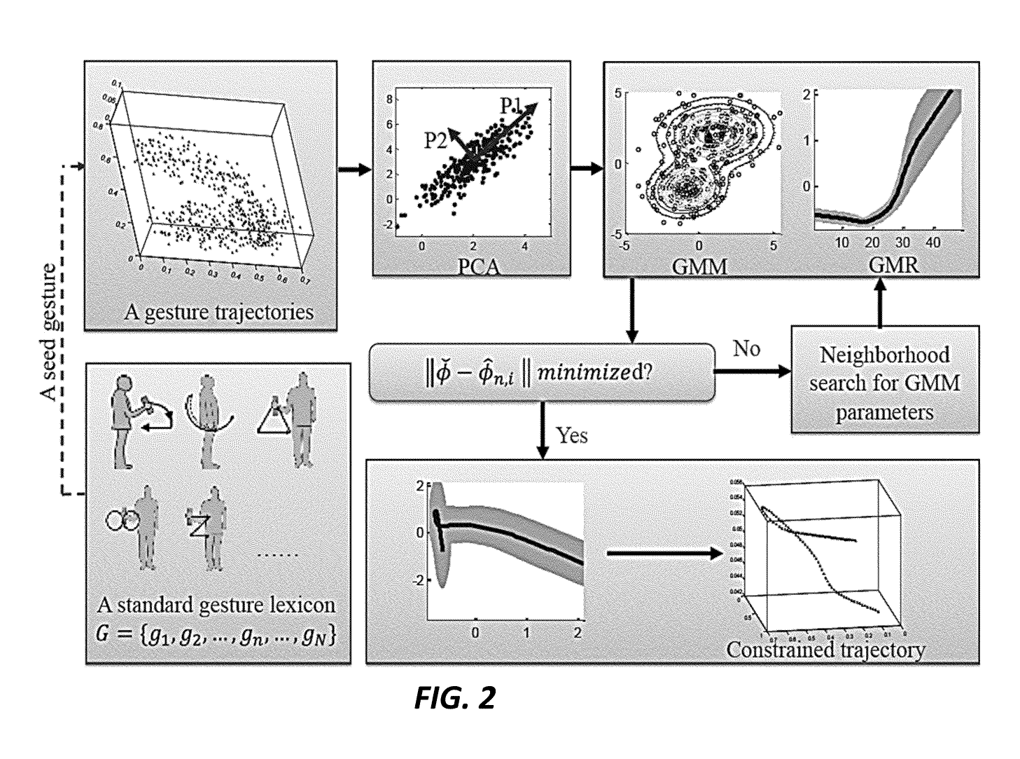

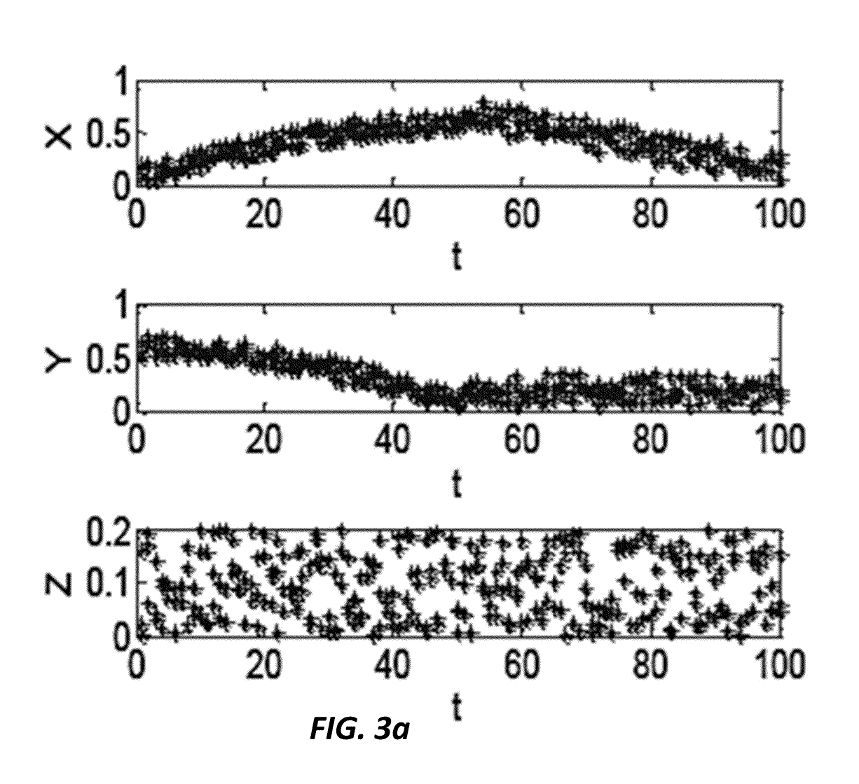

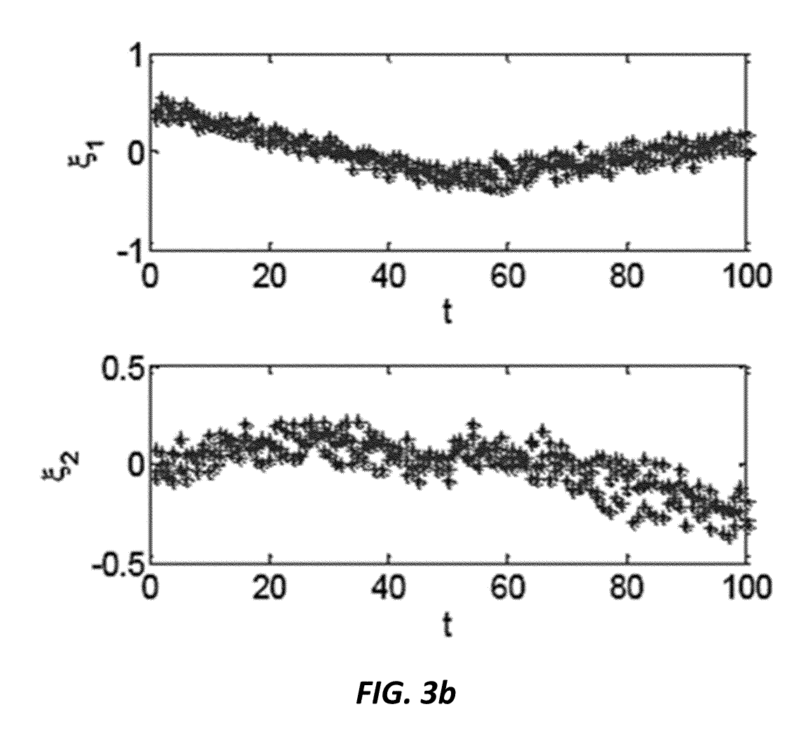

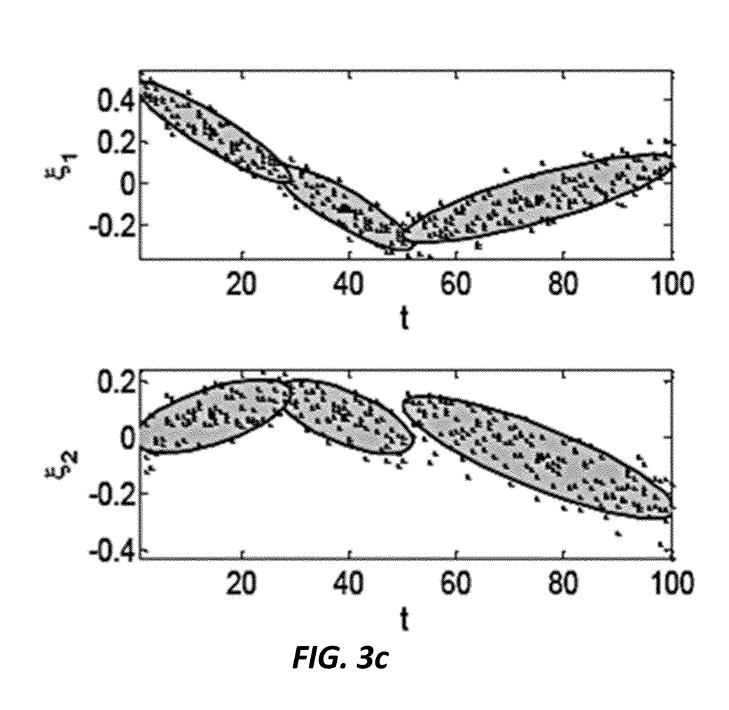

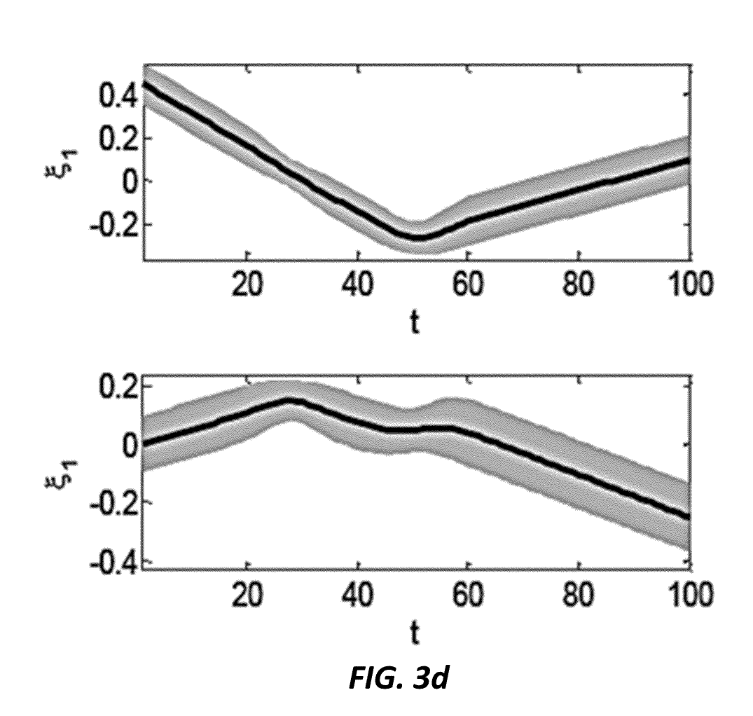

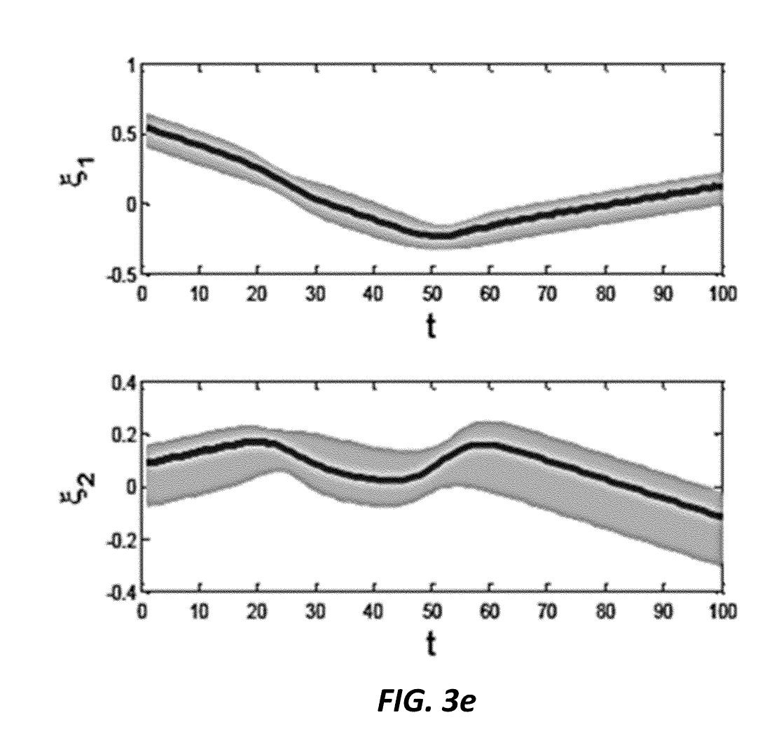

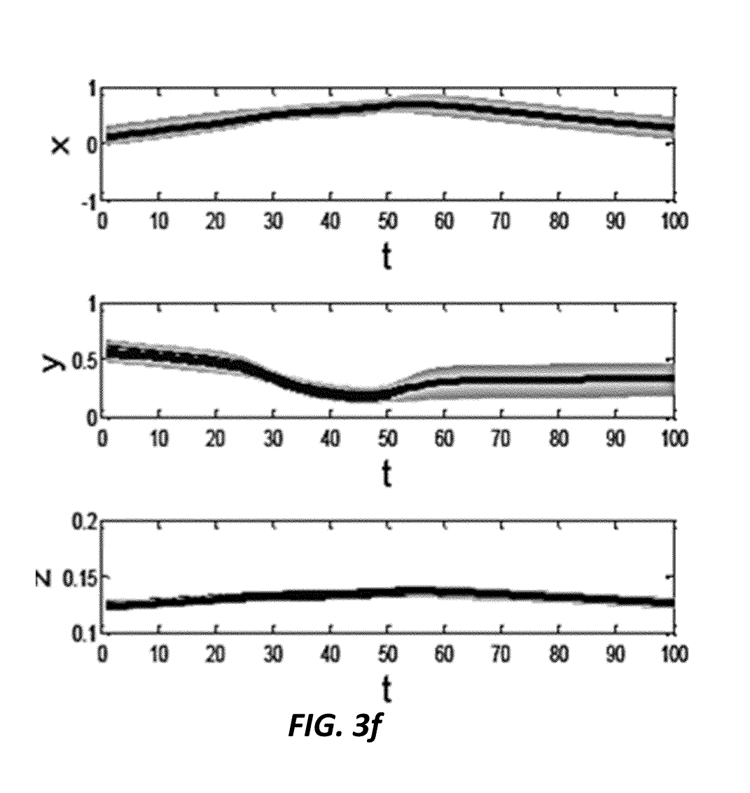

To solve this hurdle, the second step incorporates a pseudo-random gesture generation process (as shown in FIG. 2) using a combination of the gesture encoding approach (as described in the first step) and a neighborhood search method. This search procedure starts by an initial solution (or seed gesture). This seed gesture, denoted as \check{g}, is obtained through the following procedure: 3D data points of each trajectory in n are projected onto a 2D space by using principal component analysis (PCA) (denoted as ξₙ. Then, the same gesture encoding approach explained earlier (applying GMM and GMR) is used to obtain a mean gesture trajectory, which acts as the seed gesture \check{g}. In the first iteration of the search procedure, the generated gesture equals to the seed gesture. A feature vector \check{Φ} (see Sections B and C above) is then computed from the generated gesture and compared with the constrained feature vector \hat{Φ}_{n,i} (Eq. 23 and 24). Since \hat{Φ}_{n,i} characterize the constrained gestures, we need to find a gesture trajectory that can minimize a distance metric between \check{Φ} and \hat{Φ}_{n,i}. A parameter search (a neighborhood search) is conducted to tune the parameters of the Gaussian and generate a new gesture trajectory, \check{g}, and the comparison process is repeated. When the distance between \check{Φ} and \hat{Φ}_{n,i} is minimized, the mean trajectory resulting from GMR is kept as a candidate gesture ĝ_{n,i} (Eq. 24). This gesture generation process is conducted for all the gestures in G (refer to Algorithm 1 in Table 1 below). For each gesture \check{g}ₙ, Nₜᵣₐᵢₙ constrained gestures are obtained to constitute the set Ĝₙ (Eq. 25). The union of all the constrained gesture set Ĝₙ is denoted as Ω (Eq. 26). Sample results for the gesture generation step are shown in FIGS. 3a-3f. Specifically, FIG. 3a sample results of gesture generation, in particular 3D data. FIG. 3b similarly shows sample results of generation with 2D data using PCA. FIG. 3c shows the GMM model of the sample results of gesture generation. FIG. 3d shows sample results of gesture generation, specifically, the GMR results. FIG. 3e shows the neighborhood search results of the sample results of gesture generation. FIG. 3f shows the sample results of gesture generation, specifically the 3D data form back-projecting of 2D data after neighborhood search.

\check{Φ}= [symbol] (\check{g}) (23)

$${\hat{g}}_{n , i} = {arg min}_{{g}^{⋁}} ‖ {φ}^{⋁} - {\hat{φ}}_{n , i} ‖ \qquad ( 24 )$$

Ĝₙ={ĝ_{n,1}, ĝ_{n,2}, . . . , ĝ_{n,i}, . . . , ĝ_{n,N}_{ₜᵣₐᵢₙ}} (25)

Ω=Ĝ₁ ∪ Ĝ₂ ∪ Ĝₙ ∪ Ĝ_{N} (26)

TABLE 1
Algorithm 1 Constrained Gesture Generation

```
Input: a standard gesture lexicon G = {g₁,g₂,...,gₙ,...,g_{N}}
Output: constrained candidate gesture set Ω = {G₁,G₂,...,Gₙ,...,G_{N}},
where Ĝₙ = {ĝ_{n,1},ĝ_{n,2},...,ĝ_{n,i},...,ĝ_{n,N}_{ₜᵣₐᵢₙ}}
for n = 1: N
    // Feature vector projection
    // Feature extraction
    φ̅ₙ = L(gₙ)
    for i = 1: Nₜᵣₐᵢₙ
      // Laban transform Ψ = {ψ₁,φ₂,..., φᵢ,...,φ_{N}_{ₜᵣₐᵢₙ}}
      \hat{φ}_{n,i} = φ̅ᵢ(φₙ)
      // Feature extraction for a generated trajectory g
      \check{φ} = L(\check{g})
    // Neighborhood search and gesture generation
    ĝ_{n,i} = arg min_{g}||\check{φ} − \hat{φ}_{n,i}||
  end
  Ĝₙ = {ĝ_{n,1},ĝ_{n,2},...,ĝ_{n,i},...,ĝ_{n,N}_{ₜᵣₐᵢₙ}}
end
Ω = {Ĝ₁,Ĝ₂,...,Ĝₙ,...,Ĝ_{N}}
```

Experimental Results:

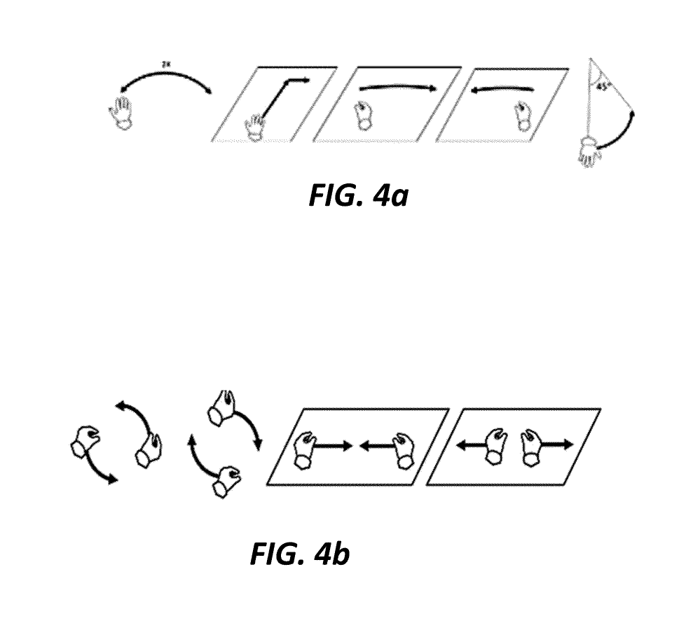

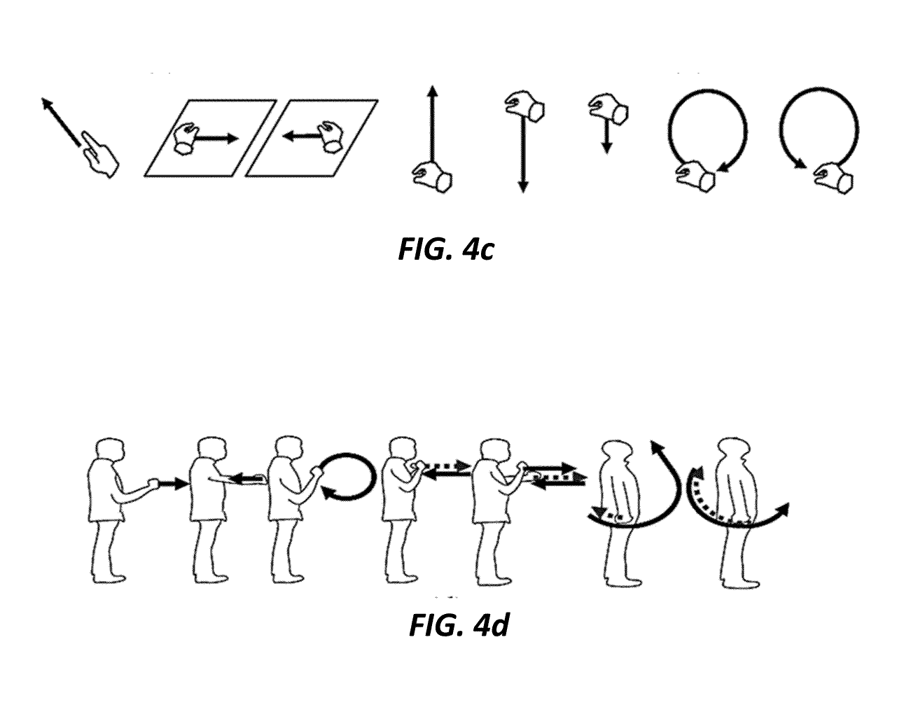

Four able-bodied subjects and three subjects with Cervical 4 (C4) to Cervical 5 (C5) SCIs were recruited to train the set of transform functions. The framework described above was applied (see FIG. 1) to obtain the candidate constrained gesture set Ĝₙ(n=1, 2, . . . , N) for each gesture gₙ in the testing lexicon. The standard gesture lexicons used in this experiment is ℑ={“Xbox”, “PointGrab”, “Wisee”, “Win8”}. The set of gesture lexicons for training is [symbol] ₜᵣₐᵢₙ={“Xbox”, “PointGrab”, “Win8”} (FIGS. 4a, 4b, and 4c) (FIGS. 4a, 4b, 4c, and 4d represent standard gesture lexicons for “Xbox” (FIG. 4a), “PointGrab” (FIG. 4b), “Win8” (FIG. 4c), and “Wisee” (FIG. 4d)) and for testing is [symbol] ₜₑₛₜ+{“Wisee”} (FIG. 4d). Note that each lexicon included a number of gestures. Given G= [symbol] ₜₑₛₜ, the objective is to generate the constrained gesture set \tilde{G} corresponding to G (as explained above). The number of gestures in “Xbox”, “PointGrab”, and “Win8” was five, four, and eight, respectively. Since for each gesture in [symbol] ₜᵣₐᵢₙ, a pre-trained transform function set Ψ is computed, the number of transform functions obtained is seventeen (5+4+8). Thus, by projecting each gesture gₙ in G using the set of transform functions Ψ, seventeen candidate gestures were obtained.

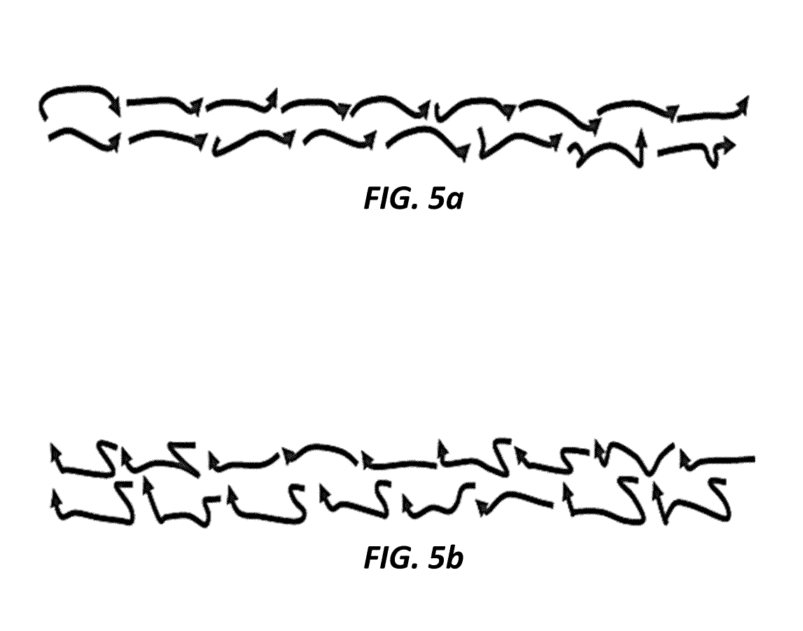

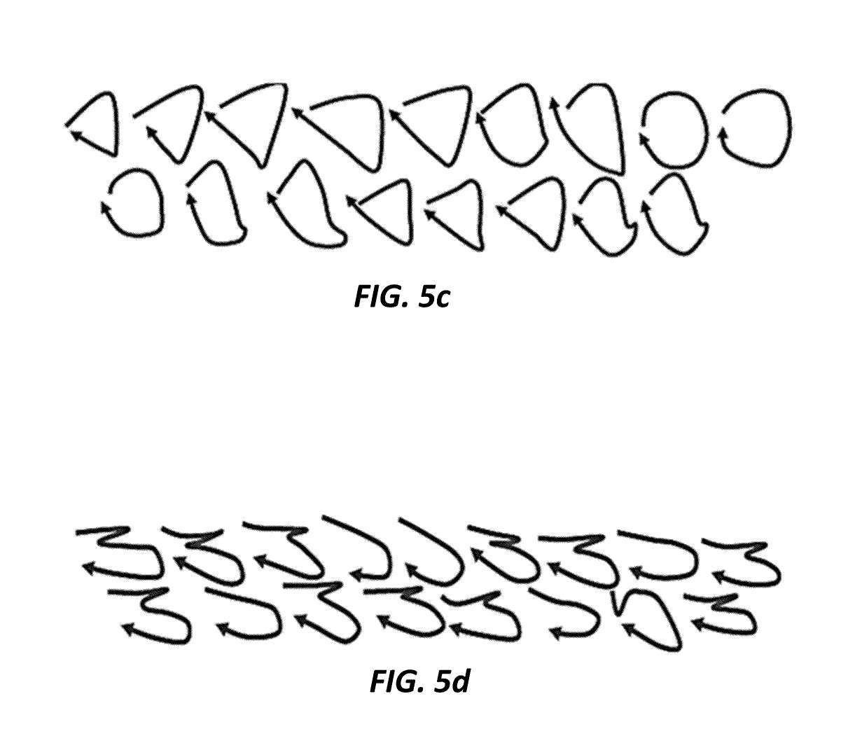

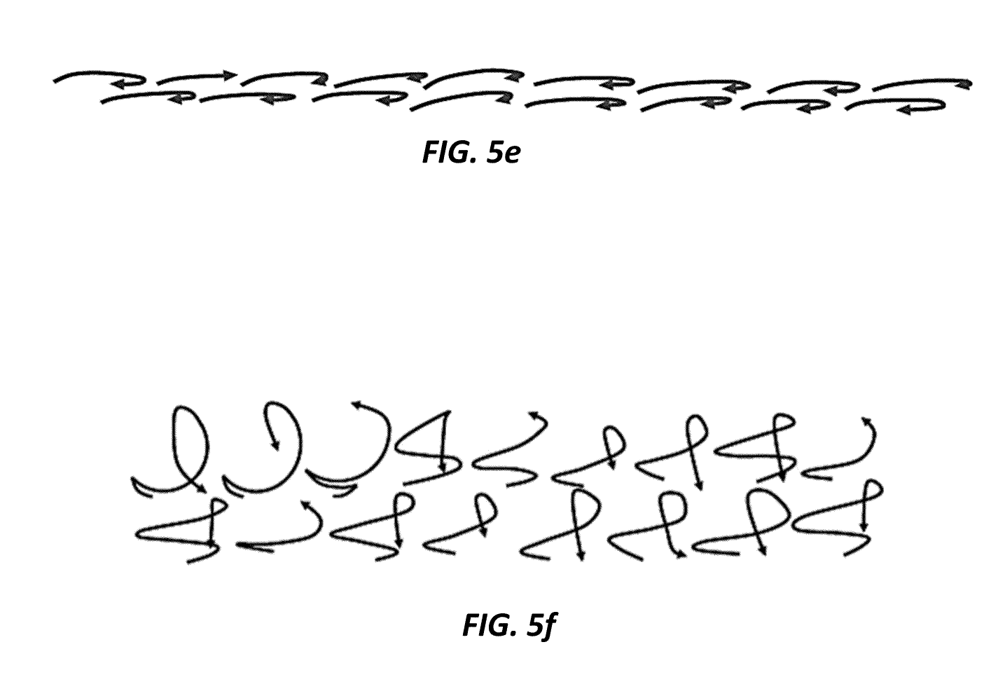

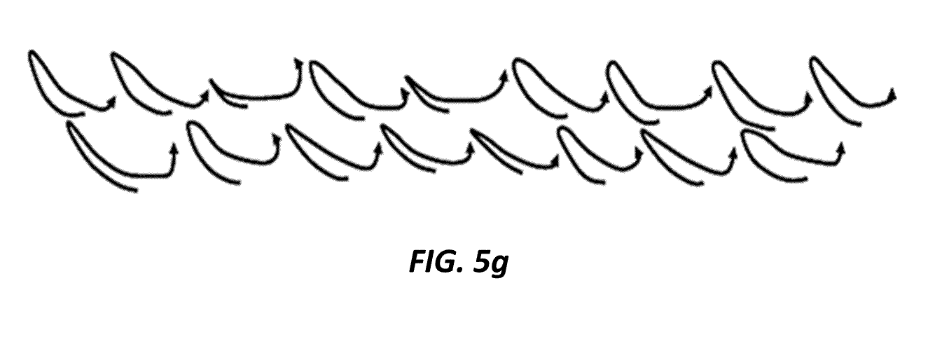

FIGS. 5a-5g illustrate the set of candidate gestures (Ĝₙ) resulting from the approach of the present disclosure. Specifically, FIGS. 5a-5g depict candidate gestures for the “Wisee” lexicon. Still referring to FIGS. 5a-5g, the figures displayed present varied forms of the original gestures. Most of the gestures exhibit more curvature than the original ones gᵢ ∈ G. Based only on appearance, it is not possible to assess their usability. To further evaluate the constrained gestures, a subjective validation was conducted with users with quadriplegia in the next section.

Gesture Validation:

Four subjects with upper extremity mobility impairments (one with Neurofibroma, two with C4 to C5 SCIs and one with a C7 SCI) were recruited in a subjective validation experiment to evaluate the constrained gestures generated by the proposed approach (FIGS. 5a-5g). The subjects were asked to respond to two questions: (1) how confident you feel you can perform the given gesture? (gestures in FIG. 4d) (Q1); (2) choose one alternative gesture better than the gesture in Q1 (Q2). For Q1, a standard gesture in the “Wisee” lexicon was shown to the subjects via a slideshow. The subjects were required to use the Borg scale (0-10) to measure the difficulty of the given gesture. The higher the score, the more difficult the gesture was to perform. For Q2, the gesture illustrated in Q1 as well as its corresponding constrained gestures were presented to the subjects. The subjects can either select the standard gesture shown in Q1 or select an alternative gesture.

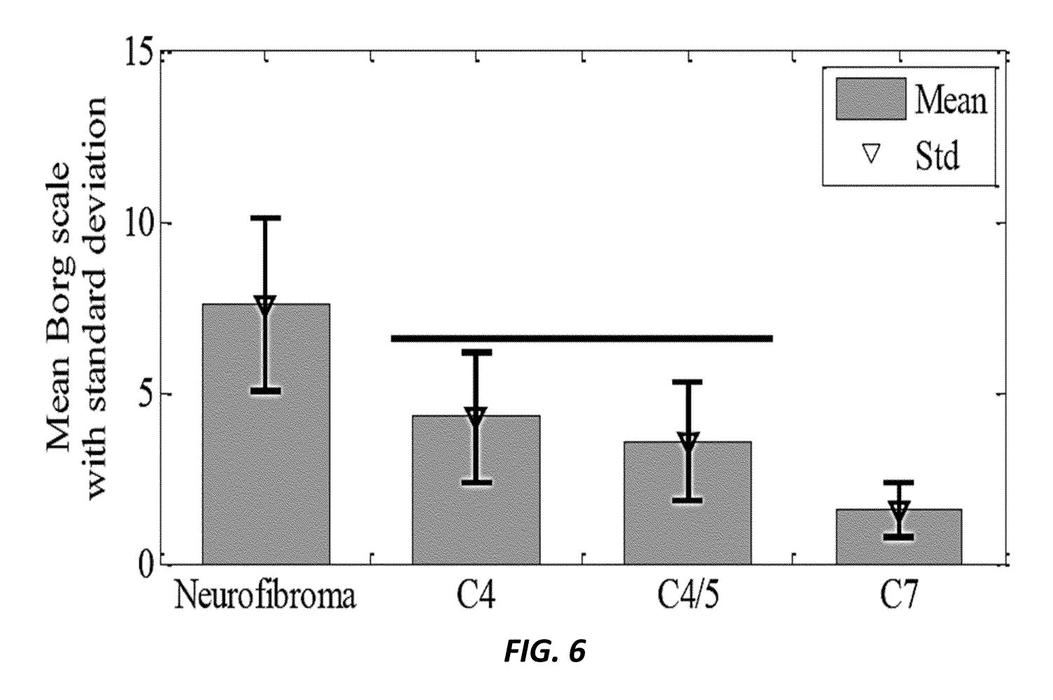

Unpaired T-test with a statistically significant value of P=0.05 tested whether there was a significant difference in effort (represented by the Borg scale) among quadriplegic subjects. The effort reported by subjects with high-level C4 and C4/5 SCIs were significantly lower than subjects with Neurofibroma (P=0.004; P=0.017) and greater than the effort reported by the subject with a low-level C7 SCI (P=0.016; P=0.005) when performing gestures in the “Wisee” lexicon (FIG. 6, which shows the average Borg scale ranking, unpaired t-test, p<0.05).

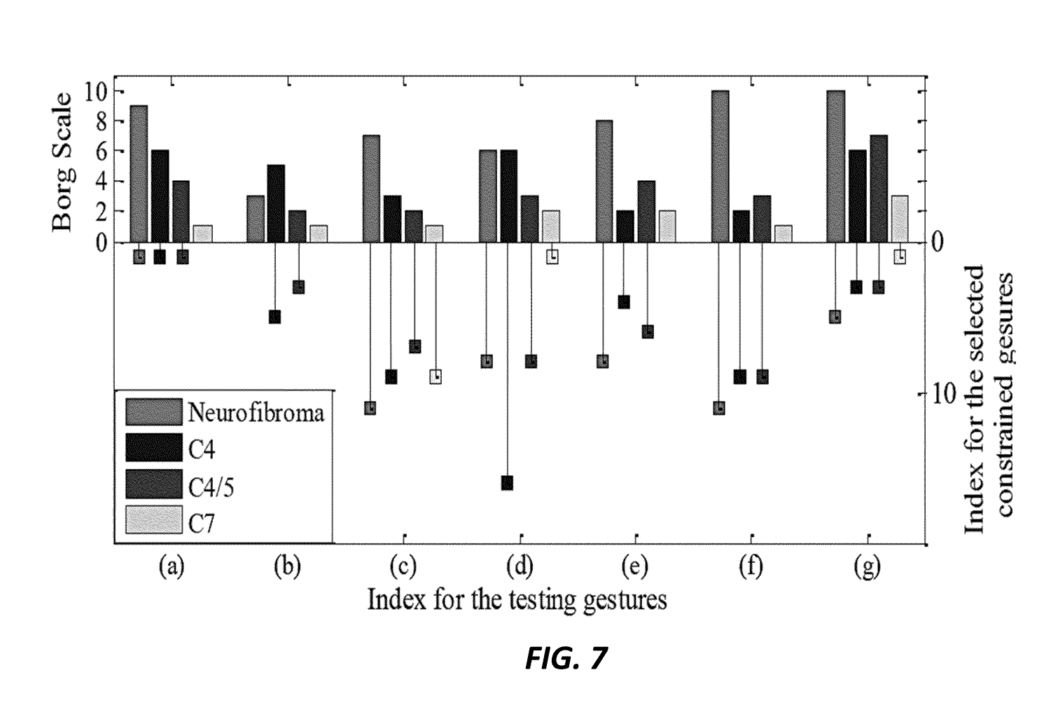

From the gesture selection results of Q2, 100% of the gestures selected by the subjects with C4 and C4/5 quadriplegia were from the constrained gestures generated by our approach. The stem graph (lower part) in FIG. 7 illustrates the index of constrained gestures selected by the subjects (see FIGS. 5a-5g for the gestures corresponding to the index). If there is no rectangle under the bar graph, it means that the standard gesture was selected rather than a constrained gesture (this occurred with the subject with C7 SCI). Even for the subject with C7 quadriplegia, who has more residual hand/arm functions than the other subjects, three out of seven constrained gestures were selected.

Conclusions:

An analytic method is proposed to address the problem of projecting standard gestures from a known manifold to an unknown constrained manifold that corresponds to the types of upper limb gestures that quadriplegics (due to middle to lower level (C4-C7) SCIs) are able to make. For each standard gesture in a set of lexicons, seventeen alternate constrained gestures with varied shape and curvature were generated using the pre-trained transform function (referred to above as the Laban Transform).

A user-based validation test was conducted with four quadriplegic subjects with impaired upper extremity mobility to evaluate the usability of the constrained gestures. The results demonstrated that subjects reported larger effort when using a gesture from the standard group and thus preferred using a gesture from our generated alternatives. For subjects with higher level (C4 and C4/5) quadriplegia, each of the selected gestures came from the constrained gesture set. For the less paralyzed subject (C7 SCI), the alternative gestures were mostly preferred. These single subject assessments independently validated that the generated gestures were more usable and sufficient for individuals with quadriplegia to engage in widespread gesture recognition technologies, including playing video games or robotic control.

Those skilled in the art will recognize that numerous modifications can be made to the specific implementations described above. The implementations should not be limited to the particular limitations described. Other implementations may be possible.

1. A method, comprising:
acquiring a plurality of gesture instances from a gesture sensor;
mapping the plurality of gesture instances;
determining a union amongst the plurality of gesture instances to thereby acquire a plurality of trajectory points;
encoding the plurality of trajectory points into a feature vector;
extracting a plurality of features from the feature vector;
normalizing the plurality of features;
computing at least one transform function from the plurality of features; and
generating constrained gestures from the at least one transform function to form at least one gesture set.

2. The method of claim 2, the plurality of gesture instances is comprised of gesture data from subjects who exhibit normal range of motion and gesture data from subjects who exhibit less than normal range of motion.

3. The method of claim 2, the feature vector is comprised of a plurality of features.

4. The method of claim 4, the plurality of features comprises spatial components, effort components, and shape components.

5. The method of claim 2, further comprising:
projecting the feature vector of a gesture instance from a standard space to a constrained space to form a constrained feature vector;
generating gestures in a vicinity space of a given arbitrary gesture through a gesture generator to form a generated gesture; and
comparing the generated gesture to the constrained feature vector.

6. A system, comprising:
a gesture sensor configured to sense physical gestures performed by a user;
a controller having a processor and a memory, the controller configured to:
acquire a plurality of gesture instances from the gesture sensor;
map the plurality of gesture instances;
determine a union amongst the plurality of gesture instances to thereby acquire a plurality of trajectory points;
encode the plurality of trajectory points into a feature vector;
extract a plurality of features from the feature vector;
normalize the plurality of features;
determine at least one transform function from the plurality of features; and
generate constrained gestures from the at least one transform function to form at least one gesture set.

7. The system of claim 6, the plurality of gesture instances is comprised of gesture data from subjects who exhibit normal range of motion and gesture data from subjects who exhibit less than normal range of motion.

8. The system of claim 7, the feature vector is comprised of a plurality of features.

9. The system of claim 8, the plurality of features comprises spatial components, effort components, and shape components.

10. The system of claim 7, wherein the controller is further configured to:
project the feature vector of a gesture instance from a standard space to a constrained space to form a constrained feature vector;
generate gestures in a vicinity space of a given arbitrary gesture through a gesture generator to form a generated gesture; and
compare the generated gesture to the constrained feature vector.
